(19) United States
(12) Patent Application Publication
(10) Pub. No.: US 2022/0358226 A1
(43) Pub. Date: Nov. 10, 2022

(54) NETWORK EDGE STORAGE APPARATUS HAVING SECURITY FEATURE

(71) Applicant: SHANDONG COMPUTER SCIENCE CENTER (NATIONAL SUPERCOMPUTER CENTER IN JINAN), Jinan (CN)

(72) Inventors: Meihong YANG, Jinan (CN); Wei ZHANG, Jinan (CN); Mengru MA, Jinan (CN); Yingjie CHEN, Jinan (CN); Zhongxin DU, Jinan (CN); Qingbin YU, Jinan (CN)

(73) Assignee: SHANDONG COMPUTER SCIENCE CENTER (NATIONAL SUPERCOMPUTER CENTER IN JINAN), Jinan (CN)

(21) Appl. No.: 17/623,889

(22) PCT Filed: Dec. 29, 2020
(86) PCT No.: PCT/CN2020/140819

§ 371 Date: Dec. 30, 2021

(30) Foreign Application Priority Data
May 15, 2020 (CN) 202010414362.0

(51) Int. Cl. G06F 21/60; H04L 67/1097; G06F 21/56; G06F 21/55

(52) U.S. Cl. CPC G06F 21/602; H04L 67/1097; G06F 21/568; G06F 21/552

(57) ABSTRACT

A network edge storage apparatus having a security feature is disclosed. A file selected from a network attached storage (NAS) device is encrypted by means of encryption software embedded in a development board, causing a user without an encryption key to fail to acquire the encrypted file from the NAS device; and/or even if a user without an encryption key can acquire the encrypted file from the NAS device by means of a local area network (LAN), the user still has no means of acquiring the specific content of the encrypted file, such that the security is improved. All files in the NAS device may be selected and encrypted to ensure that a user without an encryption key has no means of acquiring any file and the specific content thereof from the NAS device, which further improves the security.

### CROSS REFERENCE TO THE RELATED APPLICATIONS

This application is the national phase entry of International Application No. PCT/CN2020/140819, filed on Dec. 29, 2020, which is based upon and claims priority to Chinese Patent Application No. 202010414362.0, filed on May 15, 2020, the entire contents of which are incorporated herein by reference.

### TECHNICAL FIELD

The present invention relates to the field of edge storage technologies, and in particular relates to a network edge storage apparatus having a security feature.

### BACKGROUND

Edge storage means that data and other files are stored on edge nodes such as a network storage NAS device and a user host, in which NAS is also sometimes translated as network attached storage. By taking the NAS device as an example of an edge node for explanation, since the NAS device is closer to a user, the user can access the data and other files from the NAS device faster, and thus the access is accelerated. However, the data and other files stored in the NAS device have a high probability of being stolen, which will result in losses.

### SUMMARY

Aiming at the defects in the prior art, a technical problem to be solved by the present invention is how to provide a network edge storage apparatus having a security feature.

The network edge storage apparatus having a security feature according to the present invention adopts the following technical solutions.

The network edge storage apparatus includes an NAS device and a development board embedded with file sharing software, wherein the development board is mounted with the NAS device by the file sharing software, and the development board enables the file sharing software to share a file in the NAS device by a local area network (LAN); and

the development board is also embedded with encryption software, the encryption software being configured to encrypt a file selected from the NAS device.

The network edge storage apparatus having the security feature according to the present invention has the following beneficial effects.

The file selected from the NAS device is encrypted by means of the encryption software embedded in the development board, causing a user without an encryption key to fail to acquire the encrypted file from the NAS device; and/or even if a user without an encryption key can acquire the encrypted file from the NAS device by means of the LAN, the user still has no means of acquiring the specific content of the encrypted file, such that the security is improved. All files in the NAS device may be selected and encrypted to ensure that a user without an encryption key has no means of acquiring any file and the specific content thereof from the NAS device, which further improves the security.

Based on the above solution, the network edge storage apparatus having the security feature according to the present invention may be further improved as follows.

Further, the NAS device is further configured to receive an uploaded file and store the uploaded file in a preset manner, wherein the uploaded file is a file uploaded by at least one terminal to the NAS device by means of the LAN.

By use of the further solution stated above, the following beneficial effect is achieved: at least one user can upload and store the file to the NAS device by means of at least one terminal, which is more convenient.

Further, the development board is also embedded with detection software, wherein the detection software is configured to detect whether a port in the LAN is normally opened or closed and to return corresponding prompt information.

By use of the further solution stated above, the following beneficial effect is achieved: the port in the LAN is detected by the detection software; for example, if it is found that a port not used in the LAN is in an open state, operation and maintenance personnel can deal with the port according to the returned prompt information, so as to ensure the network security of the LAN, and further improve the security of the network edge storage apparatus having the security feature according to the present application.

Further, the development board is also embedded with antivirus software for scanning and virus killing of the files in the NAS device.

By use of the further solution stated above, the following beneficial effects are achieved: due to some human factors, the files stored in the NAS device may he implanted with network viruses, which, on the one hand, is harmful to computers, servers and other devices, carrying network viruses, of users, and on the other hand, possibly causes a user without an encryption key to acquire the encryption key of the file in the NAS device by the network viruses, so as to acquire the specific content of the file in the NAS device. The viruses carried by the files in the NAS device are killed by the antivirus software to guarantee that the files in the NAS device do not carry network viruses, thus further improving the security of the network edge storage apparatus having the security feature according to the present application.

Further, the development board also acquires a file change frequency of the NAS device in a previous time period, and the detection software is started once in response to the file change frequency being greater than a preset file change frequency threshold.

By use of the further solution stated above, the following beneficial effects are achieved: by reducing the frequency of starting the detection software, the handling capacity of the detection software accounts for a smaller proportion of the handling capacity of the development board, such that the development board may have more handling capacities to handle file sharing of the NAS device and to make the NAS device receive files from different terminals, and thus the efficiency is improved.

Further, the development board also acquires startup times of the detection software in a plurality of consecutive historical time periods including the previous time period, and the antivirus software is started once in response to the startup times being not less than a preset startup times threshold.

By use of the further solution stated above, the following beneficial effects are achieved: since the handling capacity of the antivirus software accounts for a large proportion of the handling capacity of the development board for virus scanning of the files in the NAS device, the efficiency of handling file sharing of the NAS device and making the NAS device receive files from different terminals will be reduced; and therefore, by reducing the frequency of starting the antivirus software, the development board may have more handling capacity to handle file sharing of the NAS device and to make the NAS device receive files from different terminals, and thus the efficiency is improved.

Further, the file sharing software is samba open-source software or WinSCP software; the antivirus software is Clam Av open-source antivirus software or ClamXav antivirus software; the detection software is ZenMap software or CurrPorts software; and the encryption software is software using a GnuPG encryption method or software using an MD5 encryption method.

Further, the development board is a smart loongson development board or a complex programmable logic device (CPLD).

### BRIEF DESCRIPTION OF THE DRAWINGS

FIG. 1 is a schematic structural diagram 1 of a network edge storage apparatus having a security feature according to an embodiment of the present invention;

FIG. 2 is a schematic structural diagram 2 of a network edge storage apparatus having a security feature according to an embodiment of the present invention; and

FIG. 3 is a schematic structural diagram 3 of a network edge storage apparatus having a security feature according to the embodiment of the present invention.

### DETAILED DESCRIPTION OF THE EMBODIMENTS

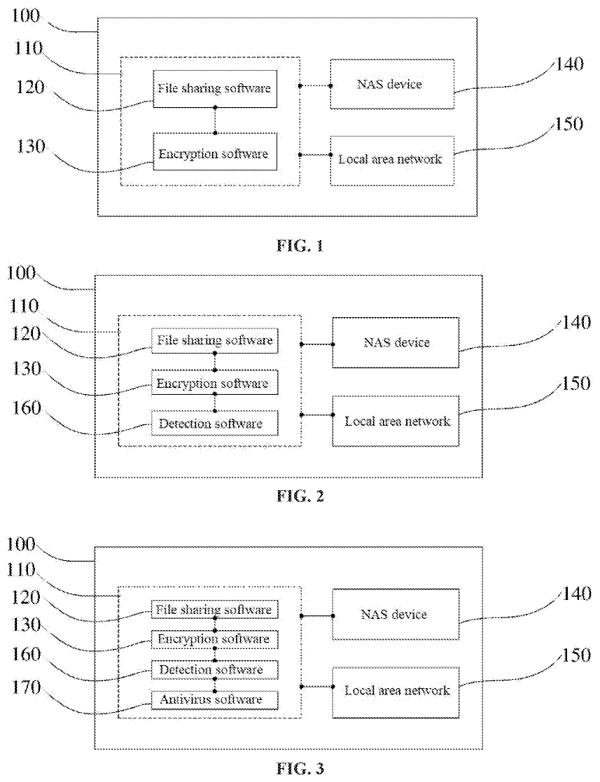

As shown in FIG. 1, a network edge storage apparatus 100 having a security feature according to an embodiment of the present invention includes an NAS device 140 and a development board 110 embedded with file sharing software 120, wherein the development board 110 is mounted with the NAS device 140 by the file sharing software 120, and the development board 110 enables the file sharing software to share a file in the NAS device 140 by an LAN 150; and

the development board 110 is also embedded with encryption software 130, wherein the encryption software 130 is configured to encrypt a file selected from the NAS device 140.

It can be understood that encryption includes the following two specific meanings:

(1) the file selected from the NAS device 140 is encrypted by means of the encryption software 130 embedded in the development board 110, causing a user without an encryption key to fail to acquire the encrypted file from the NAS device 140; and

(2) even if a user without an encryption key can acquire the encrypted file from the NAS device 140 by means of the LAN 150, the user still has no means of acquiring the specific content of the encrypted file, such that the security is improved.

All files in the NAS device 140 may be selected and encrypted to ensure that a user without an encryption key has no means of acquiring the specific content of any file from the NAS device, which further improves the security.

The development board 110 is a smart loongson development board or a CPLD, and the file sharing software 120 is samba open-source software or WinSCP software. A description will be made by taking the development board being a smart loongson development board and the file sharing software being samba open-source software as an example for explanation.

The samba open-source software is SMB protocol-based open-source file sharing software 120, which can realize file sharing between a linux system and a windows system, and only requires hardware of low configurations. Since the NAS device 140 is mounted by the samba open-source software, file sharing can be performed when a system driving the smart loongson development board 110 is a linux system or a windows system and when a host system in the LAN 150 is a linux system or a windows system, thereby achieving excellent applicability.

The encryption software 130 is software using a GnuPG encryption method or software using an MD5 encryption method. An explanation will be made below by taking the encryption software being software using a GnuPG encryption method as an example.

A program may be written based on Linux to enable a VI text editing command, and the VI text editing command receives keywords input by a user. One or more keywords may be set according to actual needs of the user, a matching search may be made from the NAS device 140 according to the keywords by means of Boolean matching to search out a corresponding file, i.e., the selected file. The searched corresponding file is then encrypted by the encryption software 130 using the GnuPG encryption method to guarantee the security.

Furthermore, a database may be established first, and a large number of sensitive words, i.e., keywords such as “confidential” and “top secret”, may be placed in the database. Then, a matching search is made for the specific contents of the files uploaded to the NAS device 140 by means of Boolean matching according to the “confidential” and “top secret” in the database. Afterwards, the searched files will be encrypted and signed by the encryption software 130 using the GnuPG encryption method to ensure the security. A user who needs to call the encrypted file may be verified by real-name authentication, and an encryption key is then issued to the user passing the verification to ensure that the user without the encryption key has no means of acquiring the specific contents of the encrypted files.

It can be understood that in the above process, files can be selected from the NAS device 140 for encryption according to actual situations fed back by the user, and the user can also independently choose whether to encrypt the uploaded files or not while uploading the files, which is more convenient.

The GnuPG encryption method is written by the GNU project in C language, and the language environment is relatively common and simple. Moreover, in most distribution versions of the Linux system nowadays, a program package of the GnuPG encryption method is self-contained by default, which omits an installation step (in the case that it is not installed, apt or yum may be used for installation), and is simple and easy to operate. When the encrypted file is called, the identity and the encryption key of the user who calls the encrypted file have to be checked, and the encrypted file is called out after both of them are confirmed.

The development board 110 may be connected to the LAN 150 by a network cable or WIFI.

Preferably, in the above technical solution, the NAS device 140 is further configured to receive an uploaded file and store the received uploaded file in a preset manner, wherein the uploaded file is a file uploaded by at least one terminal to the NAS device 140 via the LAN 150.

The terminal may be understood as a host, a server, a mobile phone, etc. For example, if there are 10 terminals, the 10 terminals and the development board 110 are all disposed in the same LAN 150, and all the 10 terminals may upload files to the NAS device 140 via the LAN 150, and call the files in the NAS device 140.

The files uploaded to the NAS device 140 via the LAN 150 include files in various forms, such as texts, pictures and videos. The preset manner may be understood as below.

The uploaded files may be subjected to detailed classification and package according to upload dates, upload forms, uploaders and confidentiality levels, and then stored in the NAS device 140, which is convenient for next calling of the files. At the same time, a file with a high confidentiality level and a high recalling frequency may be shifted and backed up for storage to prevent loss.

Furthermore, different permissions may be set for file management of the NAS device 140. For example, users whose permissions are reduced or users outside the LAN 150 may not manage and operate the files in the NAS device 140 in the LAN 150 in any form.

Preferably, in the above technical solution, the development board 110 is also embedded with detection software 160, wherein the detection software 160 is configured to detect whether a port in the LAN 150 is normally opened or closed and return corresponding prompt information.

The ports in the LAN 150 are detected by the detection software 160. For example, if it is found that a port in the LAN 150 is not in use but is in an open state, the operation and maintenance personnel may handle the port according to the returned prompt information so as to ensure the network security of the LAN 150, thereby further improving the security of the network edge storage apparatus 100 having the security feature according to the present application. The detection software 160 is ZenMap software or CurrPorts software, and ZenMap software will be taken as an example of the detection software 160 for explanation.

In the case that 10 terminals and the development board 110 are all disposed in the same LAN 150, specifically, the LAN 150 is provided with ports for connection with the 10 terminals and the development board 110 respectively, and the ports may specifically be IP ports or COM virtual ports. It is assumed that a first terminal calls a first file in the NAS device 140, then:

(1) if ZenMap software detects that a port connecting the LAN 150 to a second terminal is in an open state, the corresponding prompt information returned includes: the port connecting the LAN 150 to the second terminal is in an abnormally opened state, such that the operation and maintenance personnel may handle the port according to the returned prompt information so as to ensure the network security of the LAN 150; and

(2) if the ZenMap software detects that a port connecting the LAN 150 to the first terminal is in a closed state, the corresponding prompt information returned includes: the port connecting the LAN 150 to the first terminal is in an abnormally closed state, such that the operation and maintenance personnel may handle the port according to the returned prompt information to ensure stable operation of the network edge storage apparatus 100 having the security feature according to the present application.

The ZenMap software is an official graphical user interface of a security scanning tool NMap, and is an open-source application across platforms, i.e., across linux and windows systems. The ZenMap software may also detect whether the terminal is online or not and detect information such as an operating system and a device type of the terminal, is simple to operate and has powerful functions, e.g., supporting dozens of scanning modes, and scanning a large number of terminals. Moreover, the security scanning tool NMap also provides evasion skills of firewall and IDS, which may be comprehensively applied to specific implementations of the file sharing software 120, the encryption software 130, the detection software 160 and antivirus software 170 described below. In addition, the security scanning tool NMap also provides a powerful NSE script engine function, and a script may supplement and expand the file sharing software 120, the encryption software 130, the detection software 160 and the antivirus software 170 described below.

Preferably, in the above technical solution, the development board 110 is also embedded with the antivirus software 170 for scanning and virus killing of the files in the NAS device 140.

Due to some human factors, the files stored in the NAS device 140 may be implanted with network viruses, which, on the one hand, is harmful to computers, servers and other devices, carrying the network viruses, of the user, and on the other hand, possibly causes a user without an encryption key to acquire the encryption key of the file in the NAS device 140 by the network viruses, so as to acquire the specific content of the file in the NAS device 140. The viruses carried by the files in the NAS device 140 are killed by the antivirus software 170 to guarantee that the files in the NAS device 140 do not carry network viruses, thus further improving the security of the network edge storage apparatus 100 having the security feature according to the present application.

The antivirus software 170 is Clam Av open-source antivirus software or ClamXav antivirus software. A detailed explanation will be made by taking the antivirus software 170 being ClamXav open-source antivirus software as example.

Specifically, the Clam Av open-source antivirus software is an open-source virus scanning tool developed ins C language, is configured to detect Trojans/viruses/malware, and may update a virus database online. A program that may automatically start up the Clam Av open-source antivirus software regularly may be written by C language or other programming languages to automatically start up the Clam Av open-source antivirus software regularly for scanning and virus killing of the files in the NAS device 140. In response to discovering the viruses, virus files or immune vaccines or antivirus programs are covered with files backed up in advance to remove file viruses, so as to ensure the security of the files. Every time a new type of virus is found, it is captured and recorded, and the source, characteristics, attack forms and removal modes of the new virus are automatically analyzed and summarized, and then returned to the operation and maintenance personnel, such that the operation and maintenance personnel may conveniently make summaries and analysis to achieve the purpose of continuously expanding the virus database. Thus, the security of the network edge storage apparatus 100 having the security feature is further improved.

Preferably, in the above technical solution, the development board 110 also acquires a file change frequency of the NAS device 140 in a previous time period, and starts the detection software 160 once in response to the file change frequency being greater than a preset file change frequency threshold.

By reducing the frequency of starting the detection software 160, the handling capacity of the detection software 160 accounts for a smaller proportion of the handling capacity of the development board 110, such that the development board 110 may have more handling capacities to handle file sharing of the NAS device 140 and to make the NAS device 140 receive files from different terminals, and thus the efficiency is improved.

One time period may be 1 hour, a quarter of an hour, a minute, etc. A detailed explanation will be made by taking one time period of 1 hour and 10 hours in any day as an example.

Specifically, 00:00 is set as the initial time, and at the initial time, since any file in the NAS device 140 is not shared and the NAS device 140 does not receive the files from different terminals, the file change frequency at the initial time is 0.

From 00:00 to 01:00, if the process of sharing the files in the NAS device 140 is executed for 100 times, and the process of receiving the uploaded files by the NAS device 140 is executed for 100 times, the file change frequency of the NAS device 140 from 00:00 to 01:00 is 100+100=200, and the file change frequency of the NAS device 140 from 00:00 to 01:00 is 200/1=200. If the preset file change frequency threshold is 300, since 200<300, the detection software 160 is not started, and at this time, the previous time period may be understood as 00:00 to 01:00.

From 01:00 to 02:00, if the process of sharing the files in the NAS device 140 is executed for 200 times, and the process of receiving the uploaded files by the NAS device 140 is executed for 200 times, the file change frequency of the NAS device 140 from 01:00 to 02:00 is 200+200=400, and the file change frequency from 01:00 to 02:00 is 400/1=400. If the preset file change frequency threshold is 300, since 400>300, the detection software 160 will be started once, and at this time, the previous time period may be understood as 01:00 to 02:00.

By analogy, the file change frequency of the NAS device 140 per hour from 00:00 to 24:00 is acquired, and whether the file change frequency of the NAS device 140 is greater than the preset file change frequency threshold is determined. If the file change frequency of the NAS device 140 is greater than the preset file change frequency threshold, the detection software 160 is started once; otherwise, the detection software 160 is not started.

Preferably, in the above technical solution, the development board 110 also acquires startup times of the detection software 160 in a plurality of consecutive historical time periods including the previous time period, and starts the antivirus software 170 once in response to the startup times being not less than a preset startup times threshold.

The antivirus software 170 accounts for a large proportion of the handling capacity of the development board 110 for virus scanning of the files in the NAS device 140, which reduces the efficiency of handling file sharing of the NAS device 140 and making the NAS device 140 receive the files from different terminals. Therefore, by reducing the frequency of enabling the antivirus software 170, the development board 110 may have more handling capacity to handle file sharing of the NAS device 140, and to make the NAS device 140 receive the files from different terminals, thereby improving the efficiency.

Specifically, in response to the preset startup times threshold being 5 times and the plurality of successive historical time periods being set to 6 consecutive historical time periods, if the detection software 160 is not started from 00:00 to 01:00 and is started from 1:00 to 02:00, from 02:00 to 03:00, from 03:00 to 04:00, from 04:00 to 05:00 and from 05:00 to 06:00, the previous time period is 05:00 to 06:00, the 6 consecutive historical time periods including the previous time period are 00:00 to 01:00, 01:00 to 02:00, 02:00 to 03:00, 03:00 to 04:00, 04:00 to 05:00 and 05:00 to 06:00, and the detection software 160 is started for 5 times from 00:00 to 01:00, from 01:00 to 02:00, from 02:00 to 03:00 from 03:00 to 04:00, from 04:00 to 05:00 and from 05:00 to 06:00. Since the startup times equals the startup times threshold, the antivirus software 170 is started once.

If the detection software 160 is not started from 06:00 to 07:00 and from 07:00 to 08:00, the previous time period is 07:00 to 08:00, the 6 consecutive historical time periods including the previous time period are 02:00 to 03:00, 03:00 to 04:00, 04:00 to 05:00, 05:00 to 06:00, 06:00 to 07:00 and 07:00 to 06:00, and the detection software 160 is started for 4 times from 02:00 to 03:00, from 03:00 to 04:00, from 04:00 to 05:00, from 05:00 to 06:00, from 06:00 to 07:00 and from 07:00 to 08:00. Since the startup times equals the startup times threshold, the antivirus software 170 is not started. By analogy, whether the antivirus software 170 is started in the rest time periods thus may be derived, which will not be repeated herein.

In the present inventions, the terms “first” and “second” are only intended for description and shall not be construed to indicate or imply relative importance, or imply the number of the indicated technical features. Therefore, the features defined by “first” and “second” can indicate or imply that one or more features are included. In the description of the present invention, unless otherwise stated, the meaning of “a plurality of” means at least two, e.g., two, three, etc.

In the descriptions of the present description, the terms such as “one embodiment”, “some embodiments”, “an example”, “specific examples” and “some examples” means that the features, structures, materials or characteristics described in combination with the embodiment or example are included in at least one embodiment or example of the present invention. In the description, the schematic expressions of the above terms do not necessarily refer to the same embodiments or examples. Furthermore, the described features, structures, materials or characteristics may be combined in any suitable manner in any one or more embodiments or examples. In addition, when there is no conflict, those skilled in the art can integrate and combine different embodiments or examples described in the present description or the features of different embodiments or examples described in the present description.

Although the embodiments of the present invention are illustrated and described as above, it can be understood that these embodiments are exemplary and cannot be understood as limitations to the present invention. A person of ordinary skill in the art can make possible changes, modifications, substitutions and variations to these embodiments within the scope of the present invention.

What is claimed is:

1. A network edge storage apparatus having a security feature, comprising a network attached storage (NAS) device and a development board embedded with file sharing software, wherein the development board is mounted with the NAS device by the file sharing software, and the development board enables the file sharing software to share a file in the NAS device by a local area network (LAN); and
the development board is embedded with encryption software, wherein the encryption software is configured to encrypt a file selected from the NAS device.

2. The network edge storage apparatus having the security feature according to claim 1, wherein the NAS device is further configured to receive an uploaded file and store the uploaded file in a preset manner, wherein the uploaded file is a file uploaded by at least one terminal to the NAS device by means of the LAN.

3. The network edge storage apparatus having the security feature according to claim 2, wherein the development board is embedded with detection software, wherein the detection software is configured to detect whether a port in the LAN is normally opened or closed and to return corresponding prompt information.

4. The network edge storage apparatus having the security feature according to claim 3, wherein the development board is embedded with antivirus software for scanning and virus killing of the file in the NAS device.

5. The network edge storage apparatus having the security feature according to claim 4, wherein the development board is configured to acquire a file change frequency of the NAS device in a previous time period, and the detection software is started once in response to the file change frequency being greater than a preset file change frequency threshold.

6. The network edge storage apparatus having the security feature according to claim 5, wherein the development board is configured to acquire startup times of the detection software in a plurality of consecutive historical time periods comprising the previous time period, and the antivirus software is started once in response to the startup times being not less than a preset startup times threshold.

7. The network edge storage apparatus having the security feature according to claim 4, wherein the file sharing software is samba open-source software or WinSCP software; the antivirus software is Clam Av open-source antivirus software or ClamXav antivirus software; the detection software is ZenMap software or CurrPorts software; and the encryption software is software using a GnuPG encryption method or software using an MD5 encryption method.

8. The network edge storage apparatus having the security feature according to claim 4, wherein the development board is a smart loongson development board or a CPLD programmable logic device.

9. The network edge storage apparatus having the security feature according to claim 5, wherein the file sharing software is samba open-source software or WinSCP software; the antivirus software is Clam Av open-source antivirus software or ClamXav antivirus software; the detection software is ZenMap software or CurrPorts software; and the encryption software is software using a GnuPG encryption method or software using an MD5 encryption method.

10. The network edge storage apparatus having the security feature according to claim 6, wherein the file sharing software is samba open-source software or WinSCP software; the antivirus software is Clam Av open-source antivirus software or ClamXav antivirus software; the detection software is ZenMap software or CurrPorts software; and the encryption software is software using a GnuPG encryption method or software using an MD5 encryption method.

11. The network edge storage apparatus having the security feature according to claim 5, wherein the development board is a smart loongson development board or a CPLD programmable logic device.

12. The network edge storage apparatus having the security feature according to claim 6, wherein the development board is a smart loongson development board or a CPLD programmable logic device.
